(19) United States
(12) Patent Application Publication
(10) Pub. No.: US 2011/0144246 A1
(43) Pub. Date: Jun. 16, 2011

(54) BLENDS OF STABILIZERS FOR ALIPHATIC POLYESTERS

(75) Inventors: Raphael Dabbous, Riehen (CH); Stefano Gardi, Bologna (IT); Mirko Rossi, San Lazzaro di Savena (BO) (IT); Marcel Santi, Sissach (CH); Klaus Stoll, Binzen (DE)

(73) Assignee: BASF SE, LUDWIGSHAFEN (DE)

(21) Appl. No.: 13/000,134

(22) PCT Filed: Jun. 23, 2009
(86) PCT No.: PCT/EP2009/057766

§ 371 Date: Mar. 3, 2011

(30) Foreign Application Priority Data
Jul. 2, 2008 (EP) 08159495.4

(51) Int. Cl. C08K 5/3492; C08K 5/5377; C08K 5/5393

(52) U.S. Cl. 524/101; 524/130; 524/133

(57) ABSTRACT

The invention relates to a composition comprising a) an aliphatic polyester, b) a phenolic antioxidant, c) a phosphite or phosphonite, and d) a thiosynergist.

The present invention relates to compositions comprising a) an aliphatic polyester, preferably a lactic acid based polyester, b) a phenolic antioxidant, c) a phosphite or phosphonite, and d) a thiosynergist, as well as to the use of the stabilizer mixture for stabilizing aliphatic polyesters against oxidative, thermal or light-induced degradation.

JP-A-2006-176613 discloses thermoplastic polyester resins comprising phosphinate and diphosphinates as flame retardants, a fluorine compound, an antistatic agent and antioxidants.

The known stabilizers do not satisfy in every respect the high requirements which a stabilizer mixture is required to meet, especially with regard to shelf life, water absorption, sensitivity to hydrolysis, in-process stabilization, color properties, volatility, migration behavior, compatibility and improvement in protection against light. As a result there continues to be a need for effective stabilizer mixtures for aliphatic polyesters that are sensitive to oxidative, thermal and/or light-induced degradation.

It has now been found that a mixture of stabilizers is particularly suitable for use as stabilizers for aliphatic polyesters.

Accordingly, the invention relates to a composition comprising
a) an aliphatic polyester,
b) a phenolic antioxidant,
c) a phosphite or phosphonite, and
d) a thiosynergist.

Compositions which are of interest include those comprising as component (b) a compound of the formula I

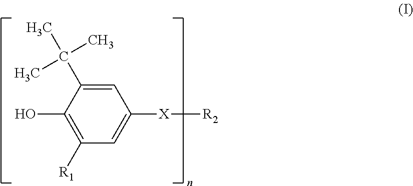

wherein
R₁ is C₁-C₄alkyl,
n is 1, 2, 3 or 4,
X is methylene,

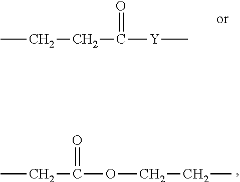

Y is oxygen or —NH—; and,
if n is 1,

### X is

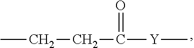

where Y is attached to R₂, and
R₂ is C₁-C₂₅alkyl; and,
if n is 2,

### X is

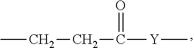

where Y is attached to R₂, and
R₂ is C₂-C₁₂alkylene, C₄-C₁₂alkylene interrupted by oxygen or sulfur; or, if Y is —NH—, R₂ is additionally a direct bond; and,
if n is 3,
X is methylene or

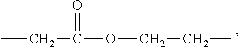

where the ethylene group is attached to R₂, and

### R₂ is

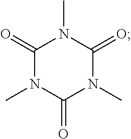

and,
if n is 4,

### X is

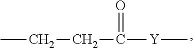

where Y is attached to R₂, and
R₂ is C₄-C₁₀alkanetetrayl.

Alkyl having up to 25 carbon atoms is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl. A preferred definition of R₁ is methyl and tert-butyl. A particularly preferred definition of R₂ is C₁-C₂₀alkyl, especially C₁-C₁₈alkyl, for example C₄-C₁₈alkyl. An especially preferred definition of R₂ is C₈-C₁₈alkyl, especially C₁₄-C₁₈alkyl, for example C₁₈alkyl.

C₂-C₁₂alkylene is a branched or unbranched radical, for example ethylene, propylene, tetramethylene, pentamethylene, hexamethylene, heptamethylene, octamethylene, decamethylene or dodecamethylene. A preferred definition of R₂ is, for example, C₂-C₁₀alkylene, especially C₂-C₈alkylene. An especially preferred definition of R₂ is, for example, C₄-C₈alkylene, especially C₄-C₆alkylene, for example hexamethylene.

C₄-C₁₂alkylene interrupted by oxygen or sulfur can be interrupted one or more times and is, for example, —CH₂—O—CH₂CH₂—O—CH₂—, —CH₂—(O—CH₂CH₂—)₂O—CH₂—, —CH₂₋(O—CH₂CH₂₋)₃O—CH₂—, —CH₂—(O—CH₂CH₂—)₄O—CH₂—, —CH₂CH₂—O—CH₂CH₂—O—CH₂CH₂— or —CH₂CH₂—S—CH₂CH₂—. A preferred definition of R₂ is, for example, C₄-C₁₀alkylene interrupted by oxygen or sulfur, especially C₄-C₈alkylene interrupted by oxygen or sulfur, for example C₄-C₆alkylene interrupted by oxygen or sulfur. An especially preferred meaning of R₂ is —CH₂CH₂—O—CH₂CH₂—O—CH₂CH₂— or —CH₂CH₂—S—CH₂CH₂—.

Alkanetetrayl having 4 to 10 carbon atoms is, for example,

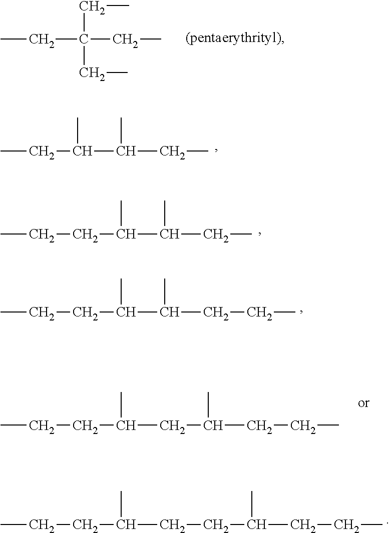

Pentaerythrityl is preferred.

Component (b) may also comprise mixtures of different sterically hindered phenols of the formula I.

Compositions which are of interest include those comprising as component (b) at least one compound of the formula I in which, if n is 1, R₂ is C₁-C₂₀alkyl.

Preference is given to compositions comprising as component (b) at least one compound of the formula I in which,

if n is 2,
R₂ is C₂-C₈alkylene, C₄-C₈alkylene interrupted by oxygen or sulfur; or, if Y is —NH—, R₂ is additionally a direct bond; and,
if n is 4,
R₂ is C₄-C₈alkanetetrayl.

Preference is likewise given to compositions comprising as component (b) at least one compound of the formula I in which

R₁ is methyl or tert-butyl,
n is 1, 2 or 4,

### X is

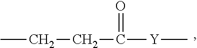

Y is oxygen or —NH—; and,
if n is 1,
R₂ is C₁₄-C₁₈alkyl; and,
if n is 2,
R₂ is C₄-C₆alkylene, or is C₄-C₆alkylene interrupted by oxygen; and
if n is 4,
R₂ is C₄-C₈alkanetetrayl.

Likewise of interest are compositions wherein component (b) is selected from the group consisting of pentaerythrityl-tetrakis[3-(3′,5′-di-tert-butyl-4-hydroxyphenyl)]propionate, octadecyl 3-(3′,5′-di-tert-butyl-4-hydroxyphenyl)propionate, ethylenebis(oxyethylene)bis-(3-(5-tert-butyl-4-hydroxy-m-tolyl)-propionate), alpha-tocopherol, 2,3-bis[3-(3,5-di-tert-butyl-4-hydroxyphenyl)propionyl]propionohydrazide, 2-propenoic acid, 2-(1,1-dimethylethyl)-6-[3-(1,1-dimethylethyl)-2-hydroxy-5-methylphenyl]methyl-4-methylphenyl ester, 3,3′,3″, 5,5′,5″-hexa-tert-butyl-α,α′,α″-(mesitylene-2,4,6-triyl)tri-p-cresol, N,N′-hexane-1,6-diylbis[3-(3,5-ditert-butyl-4-hydroxyphenylpropionamide)], diethyl((3,5-bis(1,1-dimethylethyl)-4-hydroxyphenyl)methyl)phosphonate, hexamethylene bis(3-(3,5-di-tert-butyl-4-hydroxyphenyl)propionate), calcium-bis((3,5-bis(1,1-dimethylethyl)-4-hydroxyphenyl)methyl)-ethylphosphonate), 1,3,5-tris(4-tert-butyl-3-hydroxy-2,6-xylyl)methyl)-1,3,5-triazine-2,4,6-(1H,3H,5H)-trione, 1,3,5-tris(3,5-di-tert-butyl-4-hydroxybenzyl)-1,3,5-triazine-2,4,6(1H,3H,5H)-trione, (2,4,6-trioxo-1,3,5-triazine-1,3,5(2H,4H,6H)-triyl)triethylene tris(3-(3,5-di-tert-butyl-4-hydroxyphenyl)propionate), 3,5-di-tert-butyl-4-hydroxyhydrocinnamic acid triester with 1,3,5-tris(2-hydroxyethyl)-s-triazine-2,4,6(1H,3H,5H)-trione, 2,6-di-tert-butyl-4-(4,6-bis(octylthio)-1,3,5-triazin-2-ylamino)phenol, benzenepropanoic acid 3,5-bis(1,1-dimethylethyl)-4-hydroxy-,C₇-C₉-branched and linear alkyl esters, 6,6′-di-tert-butyl-2,2′-thiodi-p-cresol, 2,2′-thiodiethylenebis(3,5-di-tert-butyl-4-hydroxyphenyl)propionate, 2,6-di-tert-butyl-4-methyl-phenol, 1,3,5-trimethyl-2,4,6-tris(3,5-di-tert-butyl-4-hydroxyphenyl)benzene, bis(3,3-bis(4′-hydroxy-3′-tert-butylphenyl)butanoic acid) glycolester, 4,4′-thiobis(2-tert-butyl-5-methylphenol), 2,2′-methylene-bis(6-(1-methyl-cyclohexyl)-p-cresol), 1,1,3-tris(2-methyl-4-hydroxy-5-tert-butylphenyl)butane, 3,9-bis[1,1-dimethyl-2-[(3-tert-butyl-4-hydroxy-5-methylphenyl)propionyloxy]ethyl]-2,4,8,10-tetraoxaspiro[5.5]undecane, 2,6-di-tert-butylphenol, 2,6-di-tert-butyl-4-nonylphenol, 4,4′-butylidenebis(6-tert butyl-3-methylphenol), 2,2′-methylene bis(4-methyl-6-tert-butylphenol), 2,2′-methylene bis(4-ethyl-6-tert-butylphenol), 2,2′-ethylidenebis(4,6-di-tert-butylphenol), 1,1-bis(2-methyl-4-hydroxy-5-tert-butylphenyl)butane, 2,5-di-tert-amylhydroquinone, 4,6-bis(octylthiomethyl-o-cresol and 4,6-bis(dodecylthiomethyl)-o-cresol or a mixture thereof.

Of special interest are compositions wherein component (b) is selected from the group consisting of pentaerythrityl-tetrakis[3-(3′,5′-di-tert-butyl-4-hydroxyphenyl)]propionate, octadecyl 3-(3′,5′-di-tert-butyl-4-hydroxyphenyl)propionate, ethylenebis(oxyethylene)bis-(3-(5-tert-butyl-4-hydroxy-m-tolyl)-propionate), alpha-tocopherol, 2,3-bis[3-(3,5-di-tert-butyl-4-hydroxyphenyl)propionyl]propionohydrazide, 2-propenoic acid, 2-(1,1-dimethylethyl)-6-[3-(1,1-dimethylethyl)-2-hydroxy-5-methylphenyl]methyl-4-methylphenyl ester, 3,3′,3″, 5,5′,5″-hexatert-butyl-α,α′,α″-(mesitylene-2,4,6-triyl)tri-p-cresol, N,N′-hexane-1,6-diylbis[3-(3,5-di-tert-butyl-4-hydroxyphenylpropionamide)], diethyl((3,5-bis(1,1-dimethylethyl)-4-hydroxyphenyl)methyl)phosphonate and calcium-bis((3,5-bis(1,1-dimethylethyl)-4-hydroxyphenyl)methyl)ethylphosphonate) or a mixture thereof.

Compositions which are of interest include those comprising as component (c) a compound from the group of the organic phosphites or phosphonites of the formulae 1 to 7

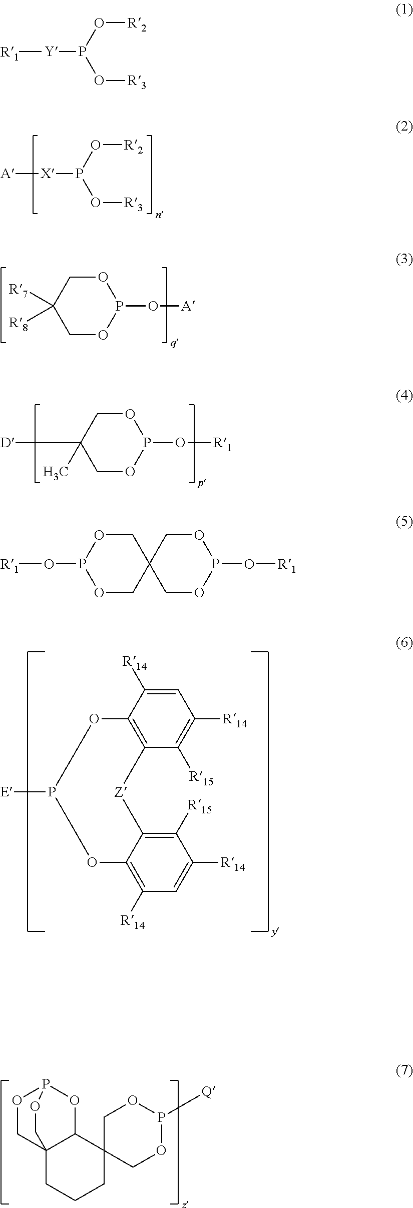

in which the indices are integral and
n′ is 2, 3 or 4; p′ is 1 or 2; q′ is 2 or 3; r′ is 4 to 12; y′ is 1, 2 or 3; and z′ is 1 to 6;
A′, if n′ is 2, is C₂-C₁₈alkylene; C₂-C₁₂alkylene interrupted by oxygen, sulfur or —NR′₄—; a radical of the formula

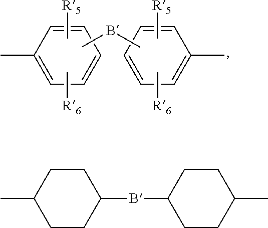

or phenylene;
A′, if n′ is 3, is a radical of the formula —C_{r′}H_{2r′-1}—;
A′, if n′ is 4, is

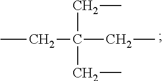

A″ has the meaning of A′ if n′ is 2;
B′ is a direct bond, —CH₂—, —CHR′₄—, —CR′₁R′₄—, sulfur or C₅-C₇cycloalkylidene, or is cyclohexylidene substituted by from 1 to 4 C₁-C₄alkyl radicals in position 3, 4 and/or 5;
D′, if p′ is 1, is methyl and, if p′ is 2, is —CH₂OCH₂—;
E′, if y′ is 1, is C₁-C₁₈alkyl, —OR′₁ or halogen;

### E′, if y is 2, is —O-A″-O—,

E′, if y is 3, is a radical of the formula R′₄C(CH₂O—)₃ or N(CH₂CH₂O—)₃;
Q′ is the radical of an at least z′-valent alcohol or phenol, this radical being attached via the oxygen atom to the phosphorus atom;
R′₁, R′₂ and R′₃ independently of one another are unsubstituted or halogen, —COOR₄′, —CN— or —CONR₄′R₄′-substituted C₁-C₁₈alkyl; C₂-C₁₈alkyl interrupted by oxygen, sulfur or —NR′₄—; C₇-C₉phenylalkyl; C₅-C₁₂cycloalkyl, phenyl or naphthyl; naphthyl or phenyl substituted by halogen, 1 to 3 alkyl radicals or alkoxy radicals having in total 1 to 18 carbon atoms or by C₇-C₉phenylalkyl; or are a radical of the formula

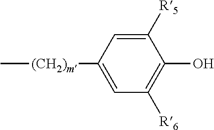

in which m′ is an integer from the range 3 to 6;
R′₄ is hydrogen, C₁-C₁₈alkyl, C₅-C₁₂cycloalkyl or C₇-C₉phenylalkyl,
R′₅ and R′₆ independently of one another are hydrogen, C₁-C₈alkyl or C₅-C₆cycloalkyl,
R′₇ and R′₈, if q′ is 2, independently of one another are C₁-C₄alkyl or together are a 2,3-dehydropentamethylene radical; and
R′₇ and R′₈, if q′ is 3, are methyl;
R′₁₄ is hydrogen, C₁-C₉alkyl or cyclohexyl,
R′₁₅ is hydrogen or methyl and, if two or more radicals R′₁₄ and R′₁₅ are present, these radicals are identical or different,
X′ and Y′ are each a direct bond or oxygen,
Z′ is a direct bond, methylene, —C(R′₁₆)₂— or sulfur, and
R′₁₆ is C₁-C₈alkyl.

Of particular interest are compositions comprising as component (c) a phosphite or phosphonite of the formula 1, 2, 5 or 6, in which

n′ is the number 2 and y′ is the number 1, 2 or 3;
A′ is C₂-C₁₈alkylene, p-phenylene or p-biphenylene,
E′, if y′ is 1, is C₁-C₁₈alkyl, —OR′₁ or fluorine;
E′, if y′ is 2, is p-biphenylene,
E′, if y′ is 3, is N(CH₂CH₂O—)₃,
R′₁, R′₂ and R′₃ independently of one another are C₁-C₁₈alkyl, C₇-C₉phenylalkyl, cyclohexyl, phenyl, or phenyl substituted by 1 to 3 alkyl radicals having in total 1 to 18 carbon atoms;
R′₁₄ is hydrogen or C₁-C₉alkyl,
R′₁₅ is hydrogen or methyl;
X′ is a direct bond,
Y′ is oxygen,
Z′ is a direct bond or —CH(R′₁₆)—, and
R′₁₆ is C₁-C₄alkyl.

Likewise of interest are compositions comprising as component (c) a phosphite or phosphonite of the formula 1, 2, 5 or 6, in which

n′ is the number 2 and y′ is the number 1 or 3;
A′ is p-biphenylene,
E′, if y′ is 1, is C₁-C₁₈alkoxy or fluorine,
E′, if y′ is 3, is N(CH₂CH₂O—)₃,
R′₁, R′₂ and R′₃ independently of one another are C₁-C₁₈alkyl, or are phenyl substituted by 2 or 3 alkyl radicals having in total 2 to 12 carbon atoms;
R′₁₄ is methyl or tert-butyl;
R′₁₅ is hydrogen;
X′ is a direct bond;
Y′ is oxygen; and
Z′ is a direct bond, methylene or —CH(CH₃)—.

Particular preference is given to compositions comprising as component (c) a phosphite or phosphonite of the formula 1, 2 or 6.

Special preference is given to compositions wherein component (c) is selected from the group consisting of tris(2,4-di-tert-butylphenyl)phosphite, bis(2,4-di-tert-butylphenyl)pentaerythritol diphosphite, tetrakis[(2,4-di-tert-butylphenyl)-4,4-biphenylenediphosphonite], tris(nonylphenyl)phosphite, bis(2,4-di-tert-butyl-6-methylphenyl)-ethyl-phosphite, 2,2′2″-nitrilo-[triethyl-tris[3,3′,5,5′-tetra-tert-butyl-1,1′-biphenyl-2,2′-diyl]]phosphite, di-stearyl-pentaerythrityl-di-phosphite, bis(2,4-dicumylphenyl)pentaerythritol diphosphite, (2,4,6-tri-tert-butylphenol)-2-butyl-2-ethyl-1,3-propanediol phosphite, bis[2,6-di-tert-butyl-4-methylphenyl]-pentaerythritol-di-phosphite, bis[nonylphenyl]pentaerythritol diphosphite and 2,2-methylenebis(4,6-di-tert-butylphenyl)-octyl phosphite or a mixture thereof.

Of special interest are compositions wherein component (c) is selected from the group consisting of tris(2,4-di-tert-butylphenyl)phosphite, bis(2,4-di-tert-butylphenyl)pentaerythritol diphosphite, tetrakis[(2,4-di-tert-butylphenyl)-4,4-biphenylenediphosphonite], di-stearyl-pentaerythrityl-di-phosphite, bis(2,4-dicumylphenyl)pentaerythritol diphosphite, bis[2,6-di-tert-butyl-4-methylphenyl]-pentaerythritol-di-phosphite and bis[nonylphenyl]pentaerythritol diphosphite or a mixture thereof.

Compositions which are of interest include those wherein component (d) is selected from the group consisting of di-octadecyl 3,3′-thiodipropionate, di-dodecyl 3,3′-thiodipropionate, mixed lauryl-stearylthiodipropionate, di-myristyl-thio-di-propionate, di-palmityl/stearyl-thio-dipropionate, lauryl-stearyl-thio-di-propionate, di-tridecyl-thio-di-propionate, di-octadecyl-disulphide, di-tert-dodecyl-disulphide, pentaerythritol octyl thiodipropionate and pentaerythritol-tetrakis-(3-laurylthiopropionate) or a mixture thereof.

Of special interest are compositions wherein component (d) is di-octadecyl 3,3′-thiodipropionate or di-dodecyl 3,3′-thiodipropionate or a mixture thereof.

The mixture of components (b), (c) and (d) is suitable for stabilizing aliphatic polyesters against oxidative, thermal or light-induced degradation.

The aliphatic polyesters of this invention are either commercially available or can be obtained according to methods well known to the one skilled in the art; for example by polycondensation reaction of aliphatic hydroxy carboxylic acid, ring-opening polymerization or polycondensation of aliphatic dibasic acids and/or ester-bond forming compounds of aliphatic dibasic acid and aliphatic diol.

Examples of aliphatic polyester resins obtained by polycondensation reaction of such aliphatic hydroxy carboxylic acids include polylactic acid, polyglycolic acid, poly-(3-hydroxybutyric acid), poly-(4-hydroxybutyric acid) and poly-(4-hydroxyvalerianic acid).

Examples of aliphatic polyester resins obtainable by ring-opening polymerization include polylactic acid, polypropiolactone, polybutyrolactone, polypivalolactone, polyvalerolactone and polycaprolactone.

Examples of aliphatic polyester resins obtainable by polycondensation reaction of such aliphatic dibasic acids and/or ester-bond forming compounds of aliphatic dibasic acids and aliphatic diols include polyethylenesuccinate, polybutylenesuccinate, polyhexamethylenesuccinate, polyethyleneadipate, polybutyleneadipate, polyhexamethyleneadipate, polyethyleneoxalate, polybutyleneoxalate, polyhexamethyleneoxalate, polyethylenesebacate and polybutylenesebacate.

Alternatively, the polylactic acid resin can be obtained by selecting a starting material having a structure of a lactide that is a cyclic lactic acid dimer, a glycolide that is a cyclic glycolic acid dimer, caprolactone, etc., and subsequent ring-opening polymerization of the starting material. The lactide can occur as a L-lactide that is a cyclic L-lactic acid dimer, a D-lactide that is a cyclic D-lactic acid dimer, a meso-lactide that is a cyclic dimer of D-lactic acid and L-lactic acid, and a DL-lactide that is a racemic mixture of D-lactide and L-lactide. In the present invention, any lactides can be used. However, the main starting material is preferably a D-lactide or a L-lactide.

The polylactic acid thus obtained may be formed by either a monomer unit derived from L-lactic acid or a monomer unit derived from D-lactic acid, or a copolymer of both units may be possible. Moreover, if the polylactic acid is a copolymer of the monomer unit derived from L-lactic acid and the monomer unit derived from D-lactic acid, the content of one of the monomer units is preferably 85 to about 100 mol %; 90 to about 100 mol % is more favorable; 95 to about 100 mol % is further more favorable; and 98 to about 100 mol % is particularly favorable. Particularly suitable polylactic acids are described in e.g. US-A-2006/142,505.

It is desired that the aliphatic polyesters are essentially free of remnant monomers. Thus, aliphatic polyester resins with a remnant monomer content of 5000 ppm or less are preferable, those containing 2000 ppm or less are more preferable, those containing 1000 ppm or less are even more preferable and those containing 500 ppm or less are still even more preferable.

The average molecular weight of the aliphatic polyester of this invention is not specifically limited. However, polyester resins with weight average molecular weight of 50 000 to 400 000 g/mol are preferable, those with 80 000 to 400 000 g/mol are more preferable and those with weight average molecular weight of 100 000-400 000 g/mol are even more preferable. The weight average molecular weight of polymers is usually determined by light scattering according to ASTM D4001-93 (2006).

Aliphatic polyester resins used herein include homopolymers obtained by using only one kind of aliphatic ester forming compound as the material and copolymers obtained by using one or more kinds of aliphatic ester forming compounds as well as mixtures of these homopolymers and copolymers. In terms of arrangements, these copolymers may be random copolymers, alternate copolymers, block copolymers or graft copolymers.

The aliphatic polyester is preferably a lactic acid-based polyester, in particular a polylactic acid. The term “polylactic acid (PLA)” designates a homo-polymer of lactic acid or lactide, preferably poly-L-lactic acid, or a co-polymer of lactic acid or lactide with other monomers, and any of their blends or alloys with other polymers. Other monomers, such as hydroxycarboxylic acids, like for example, glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lacide and any mixtures thereof.

In the compositions according to the present invention also blends of an aliphatic polyester-based resin as defined above and another suitable polymer in a weight ratio of for example 1:100 to 100:1 can be applied.

Examples of said polymers are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, Vlb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidenenorbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimides, polyesterimides, polyhydantoins and polybenzimidazoles.

18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutylenesuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate and polybutylenesebacate, as well as corresponding polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

Component (b) will preferably be added to the aliphatic polyester to be stabilized in concentrations of from 0.01 to 0.80%, preferably 0.05 to 0.30%, based on the weight of said material [component (a)].

Component (c) will preferably be added to the aliphatic polyester to be stabilized in concentrations of from 0.01 to 0.60%, preferably 0.05 to 0.20%, based on the weight of said material [component (a)].

Component (d) will preferably be added to the aliphatic polyester to be stabilized in concentrations of from 0.01 to 0.40%, preferably 0.10 to 0.20%, based on the weight of said material [component (a)].

In addition to components (a), (c), (c) and (d) the novel compositions may comprise further costabilizers (additives), typically the following:

1. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-ditert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilizers

2.1. 2-(2′-Hydroxyphenyl)benzotriazoles, for example 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-ditert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

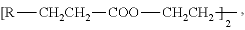

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(6-carbomethoxy-β-cyanovinyl)-2-methylindoline.

2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

5. Nitrones, for example N-benzyl-alpha-phenylnitrone, N-ethyl-alpha-methylnitrone, N-octylalpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

6. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

7. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

8. Nucleating agents, for example inorganic substances, such as talcum, metal oxides, such as titanium dioxide or magnesium oxide, phosphates, preferably organophosphates containing dioxaphosphocin moieties, most preferably in form of their lithium, sodium and [Al(OH)]²⁺ salts, carbonates or sulfates of, preferably, alkali metals, alkaline earth metals; mono-basic aluminum [Al(OH)]²⁺; organic compounds, such as mono- or polycarboxylic acids and derivatives thereof, e.g. 4-tert-butylbenzoic acid, 2,6-naphthalene-dicarboxylic acid, pimelic acid, subaric acid, succinic acid, adipic acid, diphenylacetic acid, trimesic acid, benzoic acid and any alkali metal or alikaline earth metal salt or any amide thereof, e.g. sodium succinate, sodium benzoate, or polymeric compounds, such as ionic copolymers (ionomers) and, furthermore, bisacetals of polyols, like for example 1,3:2,4-bis(3′,4′-dimethylbenzylidene)sorbitol, 1,3:2,4-di(paramethyldibenzylidene)sorbitol, 1,3:2,4-di(benzylidene)sorbitol and Irgaclear XT386 (RTM, Ciba Inc.).

9. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers; so-called nano-materials, very finely dispersed or exfoliated layer structures are particularly useful, as for example montmorillonite, bentonite and the like, as well as natural or synthetic nano-tube fillers like halloysites, zeolites or carbon-based nano-tubes or layer materials of the graphene or boron nitride type.

10. Other additives, for example plasticisers, lubricants, emulsifiers, pigments, rheology additives, catalysts, flow-control agents, optical brighteners, flameproofing agents, antistatic agents and blowing agents.

11. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyl-oxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

The costabilizers are added, for example, in concentrations of from 0.01 to 10%, based on the overall weight of the aliphatic polyester to be stabilized.

The mixture of components (a), (c), (c) and (d) can be used in particular together with UV absorbers, light stabilizers and/or processing stabilizers.

The fillers and reinforcing agents (item 9 in the list), for example talc, calcium carbonate, mica or kaolin, are added to the polyolefin in concentrations, for example, of from 0.01 to 40%, based on the aliphatic polyester to be stabilized.

Further preferred compositions comprise in addition to components (a), (b), (c) and (d) further additives as well, especially alkaline earth metal salts of higher fatty acids, for example calcium stearate, calcium lactate and/or calcium stearoyl-2-lactylate.

The mixture of components (b), (c) and (d) and other optional additives are incorporated into the aliphatic polyester according to known methods, for example before or during shaping to moulded articles or alternatively by coating the aliphatic polyester with a solution or dispersion of the components (b), (c) and (d) and subsequently evaporating the solvent. The mixture of components (b), (c) and (d) and other optional additives can also be added to the aliphatic polyester to be stabilized in the form of a masterbatch which contains these compounds, typically in a concentration of, for example, from 1.5 to 25% by weight.

The mixture of components (b), (c) and (d) and other optional additives may also be added before or during polymerization or before crosslinking.

The mixture of components (b), (c) and (d) and other optional additives may be incorporated into the material to be stabilized in pure form or encapsulated in waxes, oils or polymers.

The mixture of components (b), (c) and (d) and other optional additives, may also be sprayed onto the aliphatic polyester to be stabilized. They are able to be used to dilute other additives (e.g. the above-mentioned conventional additives) or melts thereof, so that they can also be sprayed together with these additives onto the polymer to be stabilized. Application by spraying during the deactivation of the polymerization catalysts is especially advantageous, in which case spraying is conveniently effected with the vapour used for deactivation.

The aliphatic polyesters stabilized in this way can be employed in a wide variety of forms, for example as films, fibres, tapes, moulding compositions, profiles or as binders for coating materials, especially powder coatings, adhesives or putties.

A preferred embodiment of the present invention is also a process for stabilizing an aliphatic polyester against oxidative, thermal or light-induced degradation which comprises incorporating therein or applying thereto at least a mixture of components (b), (c) and (d) and other optional additives.

Also a preferred embodiment of the present invention is the use of the mixture of components (b), (c) and (d) and other optional additives as stabilizers against oxidative, thermal or light-induced degradation for aliphatic polyesters.

The preferred mixture of components (b), (c) and (d) and other optional additives for the process and use are the same as those described for the compositions with an aliphatic polyester.

The compositions according to the invention can be advantageously used for the preparation of various shaped articles. Examples are:

I-1) Floating devices, marine applications, pontoons, buoys, plastic lumber for decks, piers, boats, kayaks, oars, and beach reinforcements.

I-2) Automotive applications, in particular bumpers, dashboards, battery, rear and front linings, mouldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.

I-3) Road traffic devices, in particular sign postings, posts for road marking, car accessories, warning triangles, medical cases, helmets, tires.

I-4) Devices for plane, railway, motor car (car, motorbike, trucks) including furnishings.

I-5) Devices for space applications, in particular rockets and satellites, e.g. reentry shields.

I-6) Devices for architecture and design, mining applications, acoustic quietized systems, street refuges, and shelters.

II-1) Appliances, cases and coverings in general and electric/electronic devices (personal computer, telephone, portable phone, printer, television-sets, audio and video devices), flower pots, satellite TV bowl, and panel devices.

II-2) Jacketing for other materials such as steel or textiles.

II-3) Devices for the electronic industry, in particular insulation for plugs, especially computer plugs, cases for electric and electronic parts, printed boards, and materials for electronic data storage such as chips, check cards or credit cards.

II-4) Electric appliances, in particular washing machines, tumblers, ovens (microwave oven), dish-washers, mixers, and irons.

II-5) Covers for lights (e.g. street-lights, lamp-shades).

II-6) Applications in wire and cable (semi-conductor, insulation and cable-jacketing).

II-7) Foils for condensers, refrigerators, heating devices, air conditioners, encapsulating of electronics, semi-conductors, coffee machines, and vacuum cleaners.

III-1) Technical articles such as cogwheel (gear), slide fittings, spacers, screws, bolts, handles, and knobs.

III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.

III-3) Sanitary articles, in particular shower cubicles, lavatory seats, covers, and sinks.

III-4) Hygienic articles, in particular diapers (babies, adult incontinence), feminine hygiene articles, shower curtains, brushes, mats, tubs, mobile toilets, tooth brushes, and bed pans.

III-5) Pipes (cross-linked or not) for water, waste water and chemicals, pipes for wire and cable protection, pipes for gas, oil and sewage, guttering, down pipes, and drainage systems.

III-6) Profiles of any geometry (window panes) and siding.

III-7) Glass substitutes, in particular extruded or co-extruded plates, glazing for buildings (monolithic, twin or multiwall), aircraft, schools, extruded sheets, window film for architectural glazing, train, transportation, sanitary articles, and greenhouse.

III-8) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

III-9) Intake and outlet manifolds.

III-10) Cement-, concrete-, composite-applications and covers, siding and cladding, hand rails, banisters, kitchen work tops, roofing, roofing sheets, tiles, and tarpaulins.

IV-1) Plates (walls and cutting board), trays, artificial grass, astroturf, artificial covering for stadium rings (athletics), artificial floor for stadium rings (athletics), and tapes.

IV-2) Woven fabrics continuous and staple, fibers (carpets/hygienic articles/geotextiles/monofilaments; filters; wipes/curtains (shades)/medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags, and bags. Non-woven fabrics such as medical fabrics and related apparel, industrial apparel, outdoor fabrics, in-home furnishing and construction fabrics.

IV-3) Membranes, insulation, covers and seals for roofs, tunnels, dumps, ponds, dumps, walls roofing membranes, geomembranes, swimming pools, curtains (shades)/sun-shields, awnings, canopies, wallpaper, food packing and wrapping (flexible and solid), medical packaging (flexible & solid), airbags/safety belts, arm- and head rests, carpets, centre console, dashboard, cockpits, door, overhead console module, door trim, headliners, interior lighting, interior mirrors, parcel shelf, rear luggage cover, seats, steering column, steering wheel, textiles, and trunk trim.

V) Films (packaging, dump, laminating, agriculture and horticulture, greenhouse, mulch, tunnel, silage), bale wrap, swimming pools, waste bags, wallpaper, stretch film, raffia, desalination film, batteries, and connectors.

VI-1) Food packing and wrapping (flexible and solid), bottles.

VI-2) Storage systems such as boxes (crates), luggage, chest, household boxes, pallets, shelves, tracks, screw boxes, packs, and cans.

VI-3) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.

VII-1) Extrusion coating (photo paper, tetrapack, pipe coating), household articles of any kind (e.g. appliances, thermos bottle/clothes hanger), fastening systems such as plugs, wire and cable clamps, zippers, closures, locks, and snap-closures.

VII-2) Support devices, articles for the leisure time such as sports and fitness devices, gymnastics mats, ski-boots, inline-skates, skis, big foot, athletic surfaces (e.g. tennis grounds); screw tops, tops and stoppers for bottles, and cans.

VII-3) Furniture in general, foamed articles (cushions, impact absorbers), foams, sponges, dish clothes, mats, garden chairs, stadium seats, tables, couches, toys, building kits (boards/figures/balls), playhouses, slides, and play vehicles.

VII-4) Materials for optical and magnetic data storage.

VII-5) Kitchen ware (eating, drinking, cooking, storing).

VII-6) Boxes for CD's, cassettes and video tapes; DVD electronic articles, office supplies of any kind (ball-point pens, stamps and ink-pads, mouse, shelves, tracks), bottles of any volume and content (drinks, detergents, cosmetics including perfumes), and adhesive tapes.

VII-7) Footwear (shoes/shoe-soles), insoles, spats, adhesives, structural adhesives, food boxes (fruit, vegetables, meat, fish), synthetic paper, labels for bottles, couches, artificial joints (human), printing plates (flexographic), printed circuit boards, and display technologies.

VII-8) Devices of filled polymers (talc, chalk, china clay (kaolin), wollastonite, pigments, carbon black, TiO₂, mica, nanocomposites, dolomite, silicates, glass, asbestos).

Thus, a further embodiment of the present invention relates to a shaped article, in particular a film, pipe, profile, bottle, tank or container, fiber containing a composition as described above.

A further embodiment of the present invention relates to a molded article containing a composition as described above. The molding is in particular obtained by injection, blow, compression, roto-molding or slush-molding or extrusion.

The examples which follow illustrate the invention in more detail. Parts and percentages are by weight.

### Viscosity:

The polylactic acid-based compound is dissolved in chloroform to a concentration of 0.5 g/dl. The viscosity is measured in an Ubbelhode-Viscometer: (Capillary number oC, 0.36 mm diameter) at 25° C. according to ISO 3105. The test is once realized with the solution containing the polymer alone and once with the solution containing the polymer plus stabilizer(s). For each measurement the specific viscosity is measured, which is equal to the difference of the viscosity of the solution minus the viscosity of the solvent divided by the viscosity of the solvent, as given below.

ηspec=(ηsolution−ηsolvent)/ηsolvent

Then the ratio of the specific viscosity of the solution containing the stabilizer(s) to the specific viscosity of the solution containing the polymer alone is calculated and expressed in percentage.

Difference in specific viscosity=100*(ηspec compound/ηspec polymer)

The higher the difference in specific viscosity the better the polymer is stabilized.

### Lightness:

As second method the lightness L* of the CIELAB color space is used, as it provides a close match of the visual assessment of degradation. The lightness L* means the following: if L*=0, the sample is black, and if L*=100, it indicates diffuse white. The measurement takes place on a Micro Color II from Dr. Lange, with pre-calibration using an opal plate, light source D65, angle 8°. The results are expressed as difference in percentage of the lightness of the non-stabilized polymer versus the stabilized polymer. The higher the increase of the lightness L* is the lower the undesired discoloration of the polymer.

### Thermal Stability:

The thermal stability of the polymer is evaluated with the help of a Thermomat 763 from Metrohm. In this measurement, the carrier gas (airflow 7 liter/hour) passes over the 3 g probe heated at 230° C. and transports the volatile substances of the polymer to a water cell; the electrical conductivity of the water is measured. The test lasts 6 hours or until the water conductivity reaches 200 μS/cm. The results are expressed as difference in percentage of the conductivity of the non-stabilized polymer versus the stabilized polymer The higher the decrease of the conductivity the better the polymer is stabilized.

### EXAMPLE 1

### Stabilization of Polylactic Acid

A polylactic acid [commercial grade from NatureWorks, USA] with melt temperature 153° C. (DSC measurement, 10 K/min) is dried during 16 hours at 80° C. in a vacuum oven, then compounded with the stabilizers according to the invention at 190° C. in a lab-scale twin screw extruder under nitrogen blanket. A recipe consisting of polylactic acid without stabilizers is also pre-dried and extruded under the same conditions. The cylindrical extrudate is directly cooled down at ambient air after extrusion. The extruded samples are submitted to the thermostability test during six hours as described above. The viscosity and the lightness are then measured as disclosed above. The results are summarized in Table 1.

TABLE 1

| | | | Improvement in |
|---|---|---|---|
| | | Improvement in | specific |
| Example | Stabilizer | lightness L* (%) | viscosity |
| 1a^{a)} | None (after extrusion) | 100 | 100 |
| 1b^{a)} | 0.2% Irganox 1076^{c)} | 72 | 156 |
| | 0.2% Irgafos 126^{d)} | | |
| | 0.5% Irganox 3052^{e)} | | |
| 1c^{b)} | 0.5% Irganox 1076^{c)} | 107 | 168 |
| | 0.2% Irgafos 126^{d)} | | |
| | 0.3% Irganox PS802^{f)} | | |

Explanation of footnotes see end of Table 3.

### EXAMPLE 2

### Stabilization of Polylactic Acid

The polylactic acid [commercial grade from NatureWorks; USA] melt temperature 150° C. (DSC measurement, 10 K/min) is first grinded under cryogenic conditions, then the additives (all in powder form) are added and mixed with a high speed mixer. The dry-blends are then dried during 16 hours at 80° C. in a vacuum oven and extruded on a Berstorff twin-screw extruder (L/D 32, D=25 mm) at 190° C. with nitrogen blanket and immediate cooling of the extrudate under water. A recipe consisting of the grinded polylactic acid, but without stabilizers, is also pre-dried and extruded under the same conditions. The results are summarized in Table 2.

TABLE 2

| | | Reduction of | |
|---|---|---|---|
| | | water | |
| | | conductivity after | Improvement in |
| Example | Stabilizer | 6 hours (%) | lightness L* (%) |
| 2a^{a)} | None (before extrusion | 98 | 111 |
| 2b^{a)} | None (after extrusion) | 100 | 100 |
| 2c^{a)} | 0.1% Irganox 245^{g)} | 21 | 119 |
| 2d^{a)} | 0.1% Irgafos 126^{d)} | 68 | 151 |
| 2e^{a)} | 0.2% Irganox PS802^{f)} | 40 | 146 |
| 2f^{a)} | 0.1% Irganox 245^{g)} | 22 | 142 |
| | 0.2% Irganox PS802^{f)} | | |
| 2g^{a)} | 0.1% Irganox 245^{g)} | 23 | 148 |
| | 0.1% Irgafos 126^{d)} | | |
| 2h^{a)} | 0.1% Irgafos 126^{d)} | 22 | 158 |
| | 0.2% Irganox PS802^{f)} | | |
| 2i^{b)} | 0.1% Irganox 245^{g)} | 17 | 160 |
| | 0.1% Irgafos 126^{d)} | | |
| | 0.2% Irganox PS802^{f)} | | |

Explanation of footnotes see end of Table 3.

### EXAMPLE 3

### Stabilization of Polylactic Acid

The polylactic acid [commercial grade from NatureWorks; USA] melt temperature 150° C. (DSC measurement, 10 K/min) is first grinded under cryogenic conditions, then the additives (all in powder form) are added and mixed with a high speed mixer. The dry-blends are then dried during 16 hours at 80° C. in a vacuum oven and extruded on a Haake twin-screw extruder (L/D 25, D=16 mm) at 190° C. with nitrogen blanket and immediate cooling of the extrudate under water. A recipe consisting of the grinded polylactic acid, but without stabilizers, is also pre-dried and extruded under the same conditions. The results are summarized in Table 3.

TABLE 3

| | | Reduction of |
|---|---|---|
| | | water |
| | | conductivity after |
| Example | Stabilizer | 6 hours (%) |
| 3a^{a)} | None (after extrusion) | 100 |
| 3b^{a)} | 0.4% Irganox 245^{g)} | 46 |
| 3c^{a)} | 0.4% Irgafos 126^{d)} | 60 |
| 3d^{a)} | 0.4% Irganox PS802^{f)} | 45 |
| 3e^{a)} | 0.2% Irganox 245^{g)} | 40 |
| | 0.2% Irganox PS802^{f)} | |
| 3f^{a)} | 0.2% Irganox 245^{g)} | 45 |
| | 0.2% Irgafos 126^{d)} | |
| 3g^{a)} | 0.2% Irgafos 126^{d)} | 35 |
| | 0.2% Irganox PS802^{f)} | |
| 3h^{b)} | 0.1% Irganox 245^{g)} | 31 |
| | 0.1% Irgafos 126^{d)} | |
| | 0.2% Irganox PS802^{f)} | |

^{a)}Comparison Example.
^{b)}Example according to the invention.
^{c)}Irganox 1076 (RTM) (Ciba Inc.) is octadecyl 3-(3′,5′-di-tert-butyl-4-hydroxyphenyl) propionate.
^{d)}Irgafos 126 (RTM) (Ciba Inc.) is bis(2,4-di-tert-butylphenyl)pentaerythritol diphosphite.
^{e)}Irganox 3052 (RTM) (Ciba Inc.) is 2-propenoic acid, 2-(1,1-dimethylethyl)-6-[3-(1,1-di-methylethyl)-2-hydroxy-5-methylphenyl]methyl-4-methylphenyl ester.
^{f)}Irganox PS802 (RTM) (Ciba Inc.) is dioctadecyl 3,3′-thiodipropionate.
^{g)}Irganox 245 (RTM) (Ciba Inc.) is ethylenebis(oxyethylene)bis(3-(5-tert-butyl-4-hydroxy-m-tolyl)-propionate).

This result shows that, also in the case where all total concentrations are equal (0.4%), the ternary combination of the invention provides better results than the single components, i.e. the synergistic efficacy is hereby demonstrated.

1. A composition comprising
a) an aliphatic polyester,
b) a phenolic antioxidant,
c) a phosphite or phosphonite and
d) a thiosynergist.

2. A composition according to claim 1, wherein component a) is a lactic acid based polyester.

3. A composition according to claim 1, wherein component a) is polylactic acid.

4. A composition according to claim 1, wherein component b) is selected from the group consisting of pentaerythrityl-tetrakis[3-(3′,5′-di-tert-butyl-4-hydroxyphenyl)]propionate, octadecyl 3-(3′,5′-di-tert-butyl-4-hydroxyphenyl)propionate, ethylenebis(oxyethylene)bis-(3-(5-tert-butyl-4-hydroxy-m-tolyl)-propionate), alpha-tocopherol, 2,3-bis[3-(3,5-di-tert-butyl-4-hydroxyphenyl)propionyl]propionohydrazide, 2-propenoic acid, 2-(1,1-dimethylethyl)-6-[3-(1,1-dimethylethyl)-2-hydroxy-5-methylphenyl]methyl-4-methylphenyl ester, 3,3′,3″,5,5′,5″-hexa-tert-butyl-α,α′,α″-(mesitylene-2,4,6-triyl)tri-p-cresol, N,N′-hexane-1,6-diylbis[3-(3,5-di-tert-butyl-4-hydroxyphenylpropionamide)], diethyl((3,5-bis(1,1-dimethylethyl)-4-hydroxyphenyl)methyl) phosphonate, hexamethylene bis(3-(3,5-di-tert-butyl-4-hydroxyphenyl)propionate), calcium-bis((3,5-bis(1,1-dimethylethyl)-4-hydroxyphenyl)methyl)-ethylphosphonate), 1,3,5-tris(4-tert-butyl-3-hydroxy-2,6-xylyl)methyl)-1,3,5-triazine-2,4,6-(1H,3H,5H)-trione, 1,3,5-tris(3,5-di-tert-butyl-4-hydroxybenzyl)-1,3,5-triazine-2,4,6(1H,3H,5H)-trione, (2,4,6-trioxo-1,3,5-triazine-1,3,5(2H,4H,6H)triyl)triethylene tris(3-(3,5-di-tert-butyl-4-hydroxyphenyl)propionate), 3,5-di-tert-butyl-4-hydroxyhydrocinnamic acid triester with 1,3,5-tris(2-hydroxyethyl)-s-triazine-2,4,6(1H, 3H, 5H)-trione, 2,6-di-tert-butyl-4-(4,6-bis(octylthio)-1,3,5-triazin-2-ylamino)phenol, benzenepropanoic acid 3,5-bis(1,1-dimethylethyl)-4-hydroxy-,C₇-C₉-branched and linear alkyl esters, 6,6′-di-tert-butyl-2,2′-thiodi-p-cresol, 2,2′-thiodiethylene-bis(3,5-di-tert-butyl-4-hydroxyphenyl)propionate, 2,6-di-tert-butyl-4-methylphenol, 1,3,5-trimethyl-2,4,6-tris(3,5-di-tert-butyl-4-hydroxyphenyl)benzene, bis(3,3-bis(4′-hydroxy-3′-tert-butylphenyl)butanoic acid) glycolester, 4,4′-thiobis(2-tert-butyl-5-methylphenol), 2,2′-methylenebis(6-(1-methyl-cyclohexyl)-p-cresol), 1,1,3-tris(2-methyl-4-hydroxy-5-tert-butylphenyl)butane, 3,9-bis[1,1-dimethyl-2-[(3-tert-butyl-4-hydroxy-5-methylphenyl)propionyloxy]ethyl]-2,4,8,10-tetraoxaspiro[5.5]undecane, 2,6-di-tert-butylphenol, 2,6-di-tert-butyl-4-nonylphenol, 4,4′-butylidenebis(6-tert butyl-3-methylphenol), 2,2′-methylene bis(4-methyl-6-tert-butylphenol), 2,2′-methylene bis(4-ethyl-6-tert-butylphenol), 2,2′-ethylidenebis(4,6-di-tert-butylphenol), 1,1-bis(2-methyl-4-hydroxy-5-tert-butylphenyl)butane, 2,5-di-tert-amyl-hydroquinone, 4,6-bis(octylthiomethyl-o-cresol, 4,6-bis(dodecylthiomethyl)-o-cresol and mixtures thereof.

5. A composition according to claim 1, wherein component c) is selected from the group consisting of tris(2,4-di-tert-butylphenyl)phosphite, bis(2,4-di-tert-butylphenyl)pentaerythritol diphosphite, tetrakis[(2,4-di-tert-butylphenyl)-4,4-biphenylenediphosphonite], tris(nonylphenyl)phosphite, bis(2,4-di-tert-butyl-6-methylphenyl)-ethyl-phosphite, 2,2′2″-nitrilo[triethyl-tris[3,3′,5,5′-tetra-tert-butyl-1,1′-biphenyl-2,2′-diyl]]phosphite, distearyl-pentaerythrityl-di-phosphite, bis(2,4-dicumylphenyl)pentaerythritol diphosphite, (2,4,6-tri-tert-butylphenol)-2-butyl-2-ethyl-1,3-propanediol phosphite, bis[2,6-di-tert-butyl-4-methylphenyl]-pentaerythritol-di-phosphite, bis[nonylphenyl]pentaerythritol diphosphite, 2,2-methylene-bis(4,6-ditert-butylphenyl)-octyl phosphite and mixtures thereof.

6. A composition according to claim 1, wherein component d) is selected from the group consisting of dioctadecyl 3,3′-thiodipropionate, di-dodecyl 3,3′-thiodipropionate, mixed lauryl-stearylthiodipropionate, di-myristyl-thio-di-propionate, di-palmityl/stearyl-thio-di-propionate, lauryl-stearyl-thio-di-propionate, di-tridecyl-thio-di-propionate, di-octadecyl-disulphide, di-tert-dodecyl-disulphide, pentaerythritol octylthiodipropionate, pentaerythritol-tetrakis-(3-laurylthiopropionate) and mixtures thereof.

7. A composition according to claim 1, in which component (b) is present in an amount of from 0.01 to 0.80% based on the weight of component (a).

8. A composition according to claim 1, in which component (c) is present in an amount of from 0.01 to 0.60% based on the weight of component (a).

9. A composition according to claim 1, in which component (d) is present in an amount of from 0.01 to 0.40% based on the weight of component (a).

10. A composition according to claim 1, comprising in addition to components (a), (b), (c) and (d) additionally further additives.

11. A composition according to claim 10, comprising as further additives UV absorbers, light-stabilizers and/or processing stabilizers.

12. A process for stabilizing an aliphatic polyester against oxidative, thermal or light-induced degradation which comprises incorporating therein or applying thereto
b) a phenolic antioxidant,
c) a phosphite or phosphonite and
d) a thiosynergist.

13. (canceled)
